(19) United States
(12) Patent Application Publication
(10) Pub. No.: US 2007/0141432 A1
(43) Pub. Date: Jun. 21, 2007

(54) Third electrode frame structure and method related thereto

(75) Inventors: Shengxian Wang, Shanghai (CN); Hai Yang, Shanghai (CN); Jun Cai, Shanghai (CN); Andrew Philip Shapiro, Schenectady, NY (US); Chang Wei, Niskayuna, NY (US); Qunjian Huang, Shanghai (CN)

Correspondence Address: SHENGXIAN WANG, ROOM 401, BUILDING 2,318, SANMEN ROAD, SHANGHAI, 240039, CN

(73) Assignee: General Electric Company

(21) Appl. No.: 11/314,758

(22) Filed: Dec. 21, 2005

(51) Int. Cl. H01M 8/02; H01M 4/94; H01M 12/06

(52) U.S. Cl. 429/34; 429/44; 429/42; 429/27

(57) ABSTRACT

A third electrode frame structure for use in a fuel cell or battery is provided. The third electrode frame structure may include a first electrode, a separator positioned on an outer perimeter of the first electrode, and a frame third electrode coupled to the separator. The separator may be positioned in a same plane between the first electrode and the third frame electrode.

### FIELD OF TECHNOLOGY

Embodiments of the invention may relate to a frame structure for use in a fuel cell or battery. Embodiments may relate to a method related to a frame structure for use in a rechargeable fuel cell or metal/air battery.

### BACKGROUND

A fuel cell may convert the chemical energy of a fuel into electricity without any intermediate thermal or mechanical processes. Energy may be released when a fuel chemically reacts with oxygen in the air. A fuel cell may convert hydrogen and oxygen into water. The conversion reaction occurs electrochemically and the energy may be released as a combination of electrical energy and heat. The electrical energy can do useful work directly, while the heat may be dispersed.

Fuel cell vehicles may operate on hydrogen stored onboard the vehicles, and may produce little or no conventional undesirable by-products. Neither conventional pollutants nor green house gases may be emitted. The byproducts may include water and heat. Systems that rely on a reformer on board to convert a liquid fuel to hydrogen produce small amounts of emissions, depending on the choice of fuel. Fuel cells may not require recharging, as an empty fuel canister could be replaced with a new, full fuel canister.

Metal/air batteries may be compact and relatively inexpensive. Metal/air cells include a cathode that uses oxygen as an oxidant and a solid fuel anode. The metal/air cells differ from fuel cells in that the anode may be consumed during operation. Metal/air batteries may be anode-limited cells having a high energy density. Metal/air batteries have been used in hearing aids and in marine applications, for example.

Metal/air cells include a cathode that uses oxygen as an oxidant and a solid fuel anode. The metal/air cells differ from fuel cells in that the anode may be consumed during operation. Metal/air batteries may be anode-limited cells having a high energy density. Metal air batteries may be almost always used as primary batteries except for a few mechanical charged types in which exhausted metal anodes may be replaced by fresh anodes mechanically.

A rechargeable fuel cell may be a kind of fuel cell using a metal hydride as an anode and an air electrode as a cathode, wherein the metal hydride functions as both a hydrogen source for fuel and as a hydrogen oxidization catalyst. Water may be employed as an energy transformation media. When electricity may be charged in a rechargeable fuel cell, water may be electrolyzed into hydrogen and oxygen, in which the produced hydrogen may be stored in the metal hydride. In reverse, when the electricity may be exported to the loads, the hydrogen from the metal hydride anode and oxygen from air constitute a fuel cell to deliver electricity. The energy stored in the rechargeable fuel cell depends on the capacity of the metal hydride anode. This functionality may avoid high pressure hydrogen container bearing, allows for higher energy density, may be more environmentally benign and costs less than conventional fuel cells or primary or secondary batteries. The principle of this kind of fuel cell may be described in application WO 2005008824, which is incorporated herein by reference.

As recyclable power sources, both rechargeable fuel cells and electrically rechargeable metal/air batteries may require a long service life. However, in such a dual functional electrochemical system, i.e., fuel cell in discharging process and electrolysis cell in charging system, the oxygen electrode often suffers from fast degradation when the cell functions as an electrolysis cell. The system efficiency also suffers by the compromise of the oxygen electrode materials for both oxygen reduction and water oxidization. It may be desirable to have a fuel cell and/or a metal/air battery having differing characteristics or properties than those currently available.

### BRIEF DESCRIPTION

Embodiments of the invention may relate to a third electrode frame structure. The third electrode frame structure may include a first electrode, a separator positioned on an outer perimeter of the first electrode, and a frame third electrode coupled to the separator. The separator may be positioned in a same plane between the first electrode and the third frame electrode.

Embodiments of the invention may relate to galvanic cells utilizing a third electrode frame structure. A galvanic cell may include a first electrode, a first separator positioned on an outer perimeter of the first electrode, and a frame third electrode coupled to the first separator. The first separator may be positioned in about the same plane as the first electrode and the third frame electrode. A second separator may be perpendicular to the first separator. The second separator may separate the first electrode and third frame electrode from a second electrode. The second electrode may be contacted through the second separator with both the first electrode and third frame electrode and one or more current collectors contacting the first, second and third electrodes.

Embodiments of the invention may relate to a method of making a third electrode frame structure for use in a galvanic cell. A method may include contacting a first electrode with a first separator on an outer perimeter of the first electrode, contacting the first separator with a third frame electrode. The separator may be positioned in about the same plane between the first electrode and third frame electrode sufficient to provide a third electrode frame structure. A second separator may be positioned perpendicular to the first separator. The second separator may be positioned between the third electrode frame assembly and a second electrode. The third electrode frame structure may be assembled with the second electrode. The second electrode may be contacted through the second separator to both the first electrode and the third electrode.

### DESCRIPTION OF THE DRAWINGS

Embodiments of the invention may be understood by referring to the following description and accompanying drawings which illustrate such embodiments. Throughout the drawings, like elements are given like numerals. In the drawings:

FIG. 1 illustrates a perspective view depicting an assembly of a cathode and a frame third electrode, according to some embodiments of the invention.

FIG. 2 illustrates a perspective view depicting a second electrode structure, according to some embodiments of the invention.

FIG. 3 illustrates an exploded view of a galvanic cell utilizing a third electrode frame structure, according to some embodiments of the invention.

FIG. 4 illustrates an exploded view of an experiment to test a third electrode frame structure, according to some embodiments of the invention.

FIG. 5 illustrates a graphical view of the cycle life of an experimental galvanic cell utilizing the third electrode frame structure, according to some embodiments of the invention.

FIG. 6 illustrates a flow diagram depicting a process for making an assembly of a cathode and a frame third electrode, according to some embodiments of the invention.

FIG. 7 illustrates a flow diagram depicting a process for making a galvanic cell utilizing an assembly of cathode and a frame third electrode, according to some embodiments of the invention.

### DETAILED DESCRIPTION

Embodiments of the invention may relate to a frame structure for use in a fuel cell or battery. Embodiments may relate to a method related to a frame structure for use in a rechargeable fuel cell or metal/air battery.

References in the specification to “one embodiment,” “an embodiment,” “an example embodiment,” indicate that the embodiment described may include a particular feature, structure, or characteristic, but every embodiment may not necessarily include the particular feature, structure, or characteristic. Moreover, such phrases may be not necessarily referring to the same embodiment. Further, when a particular feature, structure, or characteristic may be described in connection with an embodiment, it may be submitted that it may be within the knowledge of one of ordinary skill in the art to affect such feature, structure, or characteristic in connection with other embodiments whether or not explicitly described.

Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value.

As used herein, the term membrane may refer to a barrier that permits passage of hydroxyls generated at the cathode during reduction of oxygen to the anode to form water and heat. The terms cathode and cathodic electrode refer to an electrode that may include a catalyst. At the cathode, or cathodic electrode, oxygen from air is reduced by free electrons from the usable electric current, generated at the anode, that combine with protons, also generated by the anode, to form water and heat.

Electrochemical cell embodiments, as is used herein, refer to assemblies of two electrodes connected by an electrolyte, which may define an ion path between the electrodes. Electrochemical cells include voltaic cells, and batteries. Fuel cells, including rechargeable fuel cells and metal air batteries, and their stacks, are also types of electrochemical cell embodiments.

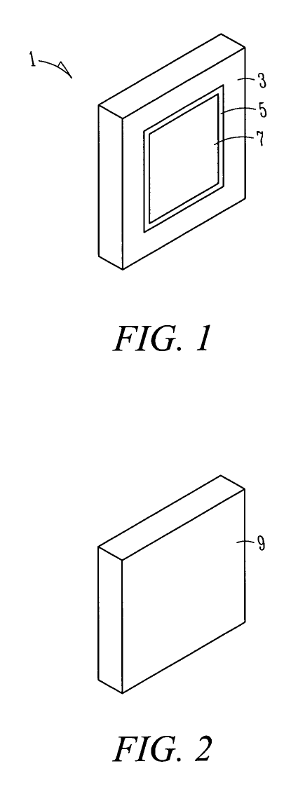

One embodiment of the invention, illustrated in FIG. 1, may include a frame third electrode assembly 1. The frame third electrode assembly 1 may include a frame third electrode 3, a separator 5, and a cathode 7.

The cathode 7 may include a core structure and may have an outer perimeter. The separator 5 may be disposed along the outer perimeter of the cathode 7. The frame third electrode 3 may surround the separator 5 on the outer perimeter. That is, the separator 5 may be positioned between the cathode 7 and the frame third electrode 3 in a single plane. Each of the cathode 7 and the frame third electrode 3 are electrodes, so that the assembly 1 includes two electrodes, electrically separated from each other.

An anode 9 is shown in FIG. 2. Because the assembly 1 of may include two electrodes, the structure illustrated allows for the two electrodes to both be in contact with other components of a fuel cell or battery, such as further separators, electrolytes, and the like.

The separator 5 may be a plastic barrier, and may be stable in alkaline environments. Examples of suitable plastic materials may include polyolefins, such as polyethylene (PE), polypropylene (PP); polystyrenics; and polyvinyl chloride (PVC); halogenated derivatives thereof; or composites thereof. In other embodiment, thermosetting resins, and composites thereof, may be used.

The anode may act as both a hydrogen oxidization catalyst or as a hydrogen storage media. The anode, or negative electrode, may be made of a substance that may be a metal hydride. The anode may include a conducting material and a binding material. Suitable conducting material may include nickel power. Suitable binding material may include one or more of polytetrafloroethylene (PTFE), polyvinylidine fluoride (PVDF), or carboxymethylcellulose (CMC).

Suitable metal hydride may include LaNi₅, or a LaNi₅ mixture with one or more rare alloys. Other examples of suitable metal hydrides may include one or more of the zirconium series hydrides. Suitable zirconium series hydrides may include one or more of ZiB₂ or titanium doped ZiB₂. Other suitable metal hydrides may include one or more of a titanium series alloy such as TiFe; or chromium, cobalt, barium, zinc or nickel doped TiFe alloy. A suitable magnesium series alloy may include one or more of Mg₂Ni or chromium, iron, cobalt, copper, zinc or vanadium doped Mg₂Ni.

The cathode, or positive electrode, may include a catalyst, a conducting material, and a binding material. Suitable catalysts may include platinum or an alloy, manganese oxide, silver, or perovskite catalyst. Such catalysts may have catalytic activity for oxygen reduction on their surface.

Conducting materials may include carbon black or metal particles or fibers. Suitable binders may function as an adhesive that can bind the component materials together, and may provide hydrophobic properties. An example of a suitable binder may be polytetrafluoroethylene (PTFE) or polyvinylidine fluoride (PVDF). Other suitable binders may include carboxymethylcellulose, fluorinated ethylene propylene, ethylene tetra-fluoro ethylene, ethylene chloro tri-fluoro ethylene, polychloro tri-fluoro ethylene, or a mixture of two or more thereof

The cathode may be an air/oxygen electrode and may include a catalyst layer and a gas diffusion layer. The gas diffusion layer, which may be positioned so as to contact the air, may include a conducting material such as carbon black and a binder, such as those disclosed above.

The frame third electrode may include a material with a low oxygen evolution over-potential. The frame third electrode may include one or more ferro-based alloys. Suitable ferro-based alloys may include stainless steel. Other examples of suitable materials may include one or more of cadmium, palladium, lead, gold, or platinum. The material may be configured to increase surface area, such as by foaming. A suitable example would be a nickel-based foam. Foams may enhance an ability of storing electrolyte solution within the volume of its pores, may provide an increased surface area for reaction, and may provide for diffusion control.

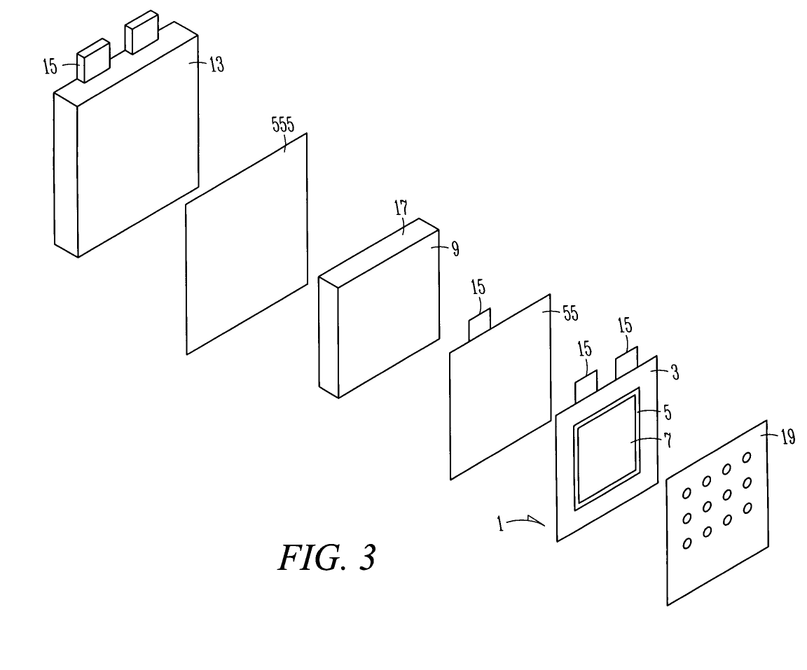

Referring to FIG. 3, an exploded view of an assembly of cathode 7 and frame third electrode assembly 1 utilized in a galvanic cell are shown. The cathode 7 and frame third electrode assembly 1 may include a cathode 7 surrounded on the perimeter by a separator 5. The frame third electrode 3 further surrounds the separator 5 in a single plane with the cathode 7.

The third electrode frame structure 1 may be in contact on a first side with a second separator 55, which may be in contact with an anode 9. The anode 9 may be able to contact both electrodes of the third electrode frame structure 1, through the second separator 55, despite the cathode 7 and frame third electrode 3 being electrically insulated from one another. A sealing ring 17 may be positioned on the perimeter of the anode 9. The anode 9 may contact a third separator 555. An air permeable cover 19 and support cover 13 may structurally support the cell. Water filling ports and electrical connections 15 may be incorporated to complete the cell.

The covers may function as a plastic housing. The plastic housing may be moldable to reduce cost and to simplify manufacturing. The covers/housing 13 and 19 may include polyethylene or polypropylene, for example. Such materials allow for a caustic resistant housing for the cell and its components. The moldable housing may provide more efficient sealing. In one embodiment, the plastic housing may be thermoset. Thus, the plastic housing may be formed by, for example, resin injection molding (RIM) or from a bulk molding compound (BMC).

Applying a voltage between the anode and the frame third electrode of the cell and reversing the electrochemical reaction may recharge an electrically rechargeable fuel cell or metal/air battery. During recharging, the cell may generate oxygen. Generated oxygen may be released to the atmosphere through the air permeable cathode if desired.

The mechanism of a rechargeable fuel cell or metal/air battery may be shown below:
In charging process:
   negative electrode: 4M+4H₂O+4e→4MH+4OH⁻
   frame third electrode: 4OH⁻→O₂+2H₂O+4e
   total electrolysis reaction: 4M+2H₂O→4MH+O₂
In discharging process:
   negative electrode: 4MH+4OH⁻+4e→4M+4H₂O
   positive electrode: O₂+2H₂O+4e→4OH⁻
   total cell reaction: 4MH+O₂→4M+2H₂O

The cathode may be used during the discharge cycle, but may be inefficient in recharging the cell. Further, the cathode may deteriorate quickly when used to recharge. A third electrode may be utilized as a separate oxygen generation electrode. According to embodiments of the invention, a frame third electrode may be utilized to extend the cycle life over traditional structures by chemically and mechanically protecting the cathode from degradation during recharge. The charge process takes place between the anode and the frame third electrode. The discharge process takes place between the anode and the cathode. Therefore, the cathode can be free from damage during the oxygen evolution reaction.

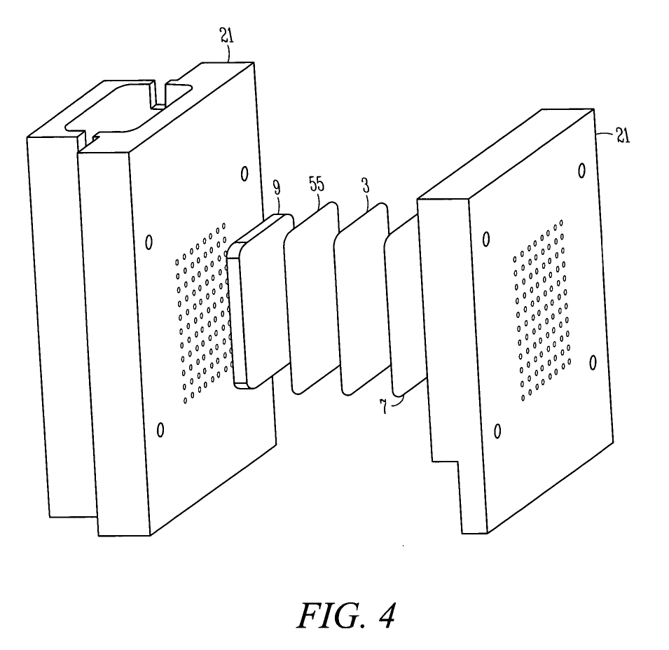

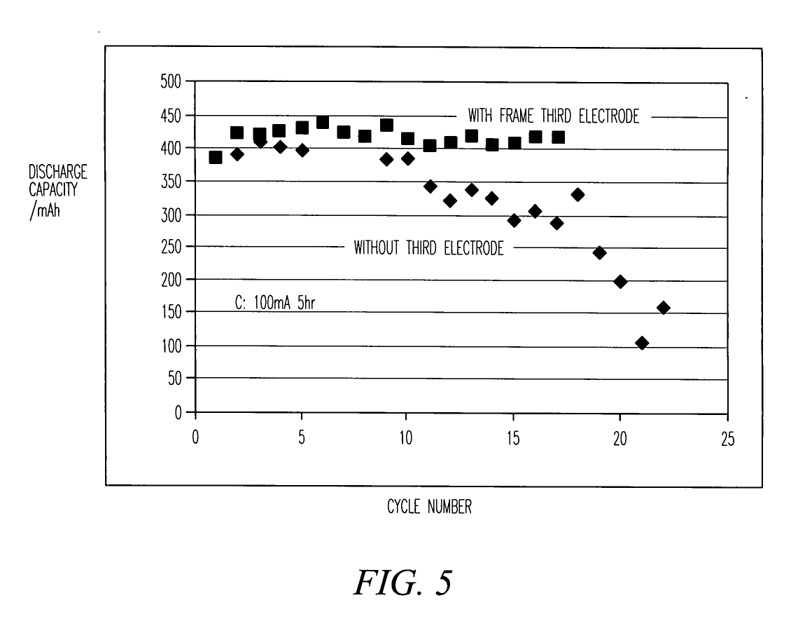

Referring to FIG. 4, an exploded view of an experiment to test a third electrode frame structure is shown. Current collectors 21 on the cathode 7 side contact a cathode 7 and a frame third electrode 3 separately. That is, two electrically insulated leads stretch out from cathode 7 and frame third 3 separately. Both the frame third electrode 3 and the cathode 7 may be separated from an anode 9 by a separator 55. FIG. 5 illustrates a graphical view of the cycle life of the experimental galvanic cell. The galvanic cell may utilize the assembly of the cathode and the frame third electrode assembly. The cell may be compared to a cell in the absence of the frame third electrode 3. The graph displays the extended cycle life provided by the frame third electrode 3.

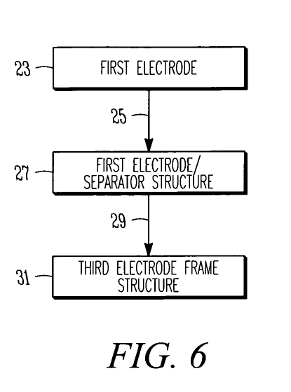

Referring to FIG. 6, a process for making a third electrode frame structure may be shown, according to some embodiments of the invention. A first electrode 23 may be contacted with a separator 25 on a perimeter, sufficient to create a first electrode/separator structure 27. The structure 27 may be then contacted with a frame third electrode 29 on an outer perimeter, sufficient to provide a third electrode frame structure 31 in which the electrodes may be positioned in a single plane. The first electrode may be a cathode. The layers may be contacted by chemical or mechanical means or a combination of both.

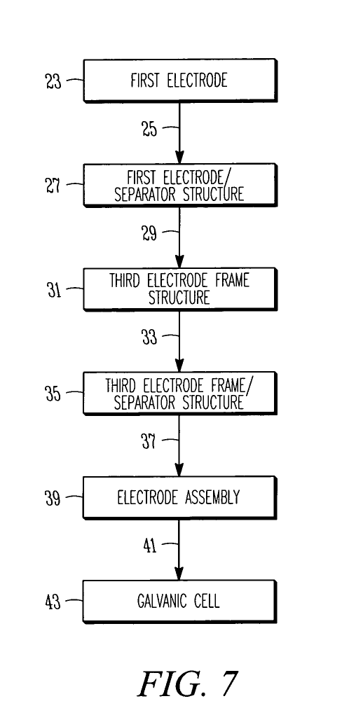

Referring to FIG. 7, a process for making a galvanic cell utilizing a third electrode frame structure may be shown. A first electrode 23 may contact a separator 25 on a peripheral edge or perimeter. The contact may be sufficient to create a first electrode/separator structure 27. The structure 27 may contact a frame third electrode 29 on the outer perimeter. The contact may be sufficient to provide a third electrode frame structure 31 in which the electrodes may be coplanar, or about coplanar. The third electrode frame structure 31 may contact a second separator 33. The contact may be sufficient to provide a third electrode frame/separator structure 35. The structure 35 may contact a second electrode 37 to provide an electrode assembly 39. The second electrode may be positioned to contact both electrodes of the third electrode frame structure 31 through at least one separator. The electrode assembly 39 may be assembled 41 during molding of a housing structure to provide a galvanic cell 43. The moldable housing may provide structural support and electrical support. Further, the housing may be configured to define one or more apertures through which electrolyte, water and air may access the housing interior.

The foregoing examples are merely illustrative of some of the features of the invention. The appended clauses are intended to define the invention as broadly as it has been conceived and the examples herein presented are illustrative of selected embodiments from a manifold of all possible embodiments. Accordingly it is Applicants' intention that the appended clauses are not to be limited in definition by the choice of examples utilized to illustrate features of the present invention. As used in the clauses, the word “comprises” and its grammatical variants logically also subtend and include phrases of varying and differing extent such as for example, but not limited thereto, “consisting essentially of” and “consisting of.” Where necessary, ranges have been supplied; those ranges are inclusive of all sub-ranges there between. It is to be expected that variations in these ranges will suggest themselves to a practitioner having ordinary skill in the art and, where not already dedicated to the public, those variations should be construed to be covered in the appended clauses. It is also anticipated that advances in science and technology will make equivalents and substitutions possible that are not now contemplated by reason of the imprecision of language and these variations should also be construed where possible to be covered by the appended clauses.

What is claimed is:

1. An electrode assembly, comprising:
a first electrode having an outer perimeter;
a separator secured to the outer perimeter of the first electrode; and
a frame third electrode secured to an outer perimeter of the separator,
wherein the separator is coplanar with the first electrode and the third frame electrode.

2. The electrode assembly of claim 1, wherein the first electrode is a cathode.

3. The electrode assembly of claim 2, wherein the cathode comprises an air/oxygen electrode having a catalyst layer and gas diffusion layer.

4. The electrode assembly of claim 3, wherein the catalyst layer comprises a catalyst, a conductive material, and a binder.

5. The electrode assembly of claim 4, wherein the catalyst comprises a metal catalyst, a metal oxide catalyst, or a perovskite catalyst.

6. The electrode assembly of claim 3, wherein the gas diffusion layer comprises carbon black and a binder.

7. The electrode assembly of claim 6, wherein the binder comprises one or more of polytetrafluoroethylene, carboxymethylcellulose, polyvinylidene fluoride, fluorinated ethylene propylene, ethylene tetra-fluoro ethylene, ethylene chloro tri-fluoro ethylene, polychloro tri-fluoro ethylene, or a mixture of two or more thereof.

8. The electrode assembly of claim 1, wherein the separator is an electrical insulating material.

9. The electrode assembly of claim 8, wherein the separator comprises one or more of polytetrafluoroethylene, carboxymethylcellulose, polyvinylidene fluoride, fluorinated ethylene propylene, ethylene tetra-fluoro ethylene, ethylene chloro tri-fluoro ethylene, or polychloro tri-fluoro ethylene.

10. The electrode assembly of claim 1, wherein the frame third electrode comprises one or more ferro-based alloys.

11. The electrode assembly of claim 10, wherein the frame third electrode comprises stainless steel.

12. The electrode assembly of claim 1, wherein the frame third electrode comprises one or more of cadmium, cobalt, lead, gold, nickel, palladium, or platinum.

13. The electrode assembly of claim 12, wherein the frame third electrode comprises a nickel-based foam.

14. A metal/air battery comprising the electrode assembly of claim 1, wherein the galvanic cell is a metal/air battery.

15. A fuel cell comprising the electrode assembly of claim 1, wherein the galvanic cell is a fuel cell.

16. A galvanic cell, comprising:
a first electrode having an outer perimeter;
a first separator that is secured to the outer perimeter of the first electrode, and that is coplanar with the first electrode;
a frame third electrode that is coupled to the first separator, and that is coplanar with the first electrode;
a second separator that is oriented to be about perpendicular to the first separator, wherein the second separator is configured to spatially separate the first electrode and the third frame electrode from a second electrode;
a second electrode that is in communication with at least the first electrode and the third frame electrode, and that communicates through the second separator; and
a plurality of current collectors, and at least one of the plurality of current collectors contacting a respective one each of the first electrode, the second electrode, and the third electrode separately from each other.

17. The galvanic cell of claim 16, wherein the first electrode is a cathode and the second electrode is an anode.

18. The galvanic cell of claim 16, wherein a moldable housing encases at least the first electrode, the first separator, the frame third electrode, the second separator, and the second electrode.

19. A method, comprising:
contacting a first electrode with a first separator on an outer perimeter of the first electrode;
contacting the first separator with a third frame electrode, wherein the separator is in a same plane and disposed between the first electrode and the third frame electrode to provide a third electrode frame structure;
securing a second separator perpendicular to the first separator, so that the second separator is positioned between the third electrode frame assembly and a second electrode; and the second electrode communicates through the second separator to both the first electrode and the third electrode, and thereby to make a third electrode frame structure for use in a galvanic cell.

20. The method of claim 19, wherein contacting comprises contacting by chemical means, mechanical means, or a combination thereof.

22. The method of claim 19, wherein the first electrode is a cathode and the second electrode is an anode.

23. An electrochemical cell system, comprising:
means for separating a first electrode from a third frame electrode on an outer perimeter of the first electrode, and which is in about the same plane as the first electrode and the third frame electrode; and
means for separating the first electrode from a second electrode, and which is about perpendicular to the means for separating a first electrode from a third frame electrode, and
the first electrode, the third frame electrode, or both the first electrode and the third frame electrode are capable of communicating with the second electrode through the means for separating the first electrode from a second electrode.

24. The system as defined in claim 23, further comprising means for housing at least the first electrode, the second electrode, the third frame electrode, and all of the separating means.

25. The system as defined in claim 24, wherein the housing means comprises a moldable plastic that is thermoformable material or a reactive injection moldable material.
